(19) United States
(12) Patent Application Publication
(10) Pub. No.: US 2020/0274394 A1
(43) Pub. Date: Aug. 27, 2020

(54) COMMUNICATION DEVICE AND ELECTRONIC DEVICE HAVING PROTECTIVE FUNCTION

(71) Applicant: Maps, Inc., Seoul (KR)

(72) Inventors: Joon RHEE, Seoul (KR); Jong Tae HWANG, Seoul (KR); Hyun Ick SHIN, Seoul (KR); Ki Woong JIN, Anyang-si (KR)

(73) Assignee: Maps, Inc., Seoul (KR)

(21) Appl. No.: 16/092,278

(22) PCT Filed: Apr. 6, 2017
(86) PCT No.: PCT/KR2017/003768

§ 371 Date: Oct. 9, 2018

(30) Foreign Application Priority Data
Apr. 6, 2016 (KR) 10-2016-0042329
Jun. 14, 2016 (KR) 10-2016-0073753

(51) Int. Cl. H02J 50/12; H02J 50/70; H02J 7/04

(52) U.S. Cl. CPC H02J 50/12; H02J 7/04; H02J 50/70

(57) ABSTRACT

Provided are a communication device and an electronic device each having a protective function. In one embodiment, the communication device includes a transceiving device configured to transmit or receive a signal, a communication circuit configured to be selectively connected to the transceiving device, and a wireless power input detector configured to protect the communication circuit from a wireless power signal by detecting whether the signal is the wireless power signal which is input for charging and generating a control signal for selectively disconnecting the communication circuit from the transceiving device.

### TECHNICAL FIELD

The present invention relates to wireless power transmitting and receiving technology.

### BACKGROUND ART

A short-range communication module establishing communication by forming a magnetic field of a frequency band of several to several tens of MHz has been applied and used as a module for radio-frequency identification (hereinafter referred to as ‘RFID’), near-field communication (hereinafter referred to as ‘NFC’), etc. Especially, various applications using an NFC method have been applied to portable terminals such as cellular phones and have attracted much attention as auxiliary payment means.

Wireless charging is performed at a low frequency band of 100 kHz in the Qi of the Wireless Power Consortium (hereinafter referred to as ‘WPC’) or a Power Matters Alliance (PMA) method, which is an inductive type wirelessly charging methods. In contrast, NFC is established using an Industry-Science-Medical band of 13.56 MHz (hereinafter referred to as the ‘ISM band’). Accordingly, the frequency band used here is considerably different from those used in the above methods and thus a serious problem is not caused due to little interference between the Qi or the PMA method and the NFC.

In contrast, an ISM band of 6.78 MHz used in the Alliance for Wireless Power (hereinafter referred to as ‘A4WP’) using magnetic resonance is very close to the frequency band of 13.56 MHz used in the NFC and thus power supplied from an A4WP power transmitting unit (PTU) may be unintentionally supplied to an NFC module via an NFC antenna. In general, low power is transmitted from or received by the NFC module and thus excessive power is supplied to the NFC module and the NFC module may be damaged when a large amount of power is supplied thereto from the A4WP PTU. In addition, even if operating frequencies are in significantly different bands in the WPC or the PMA method, a communication circuit may be damaged as in NFC when the amount of power transmitted increases.

### DISCLOSURE

### Technical Problem

In an embodiment, a communication device and an electronic device each having a protective function during wireless charging are proposed.

### Technical Solution

A communication device according to an embodiment includes a transceiving device configured to transmit or receive a signal; a communication circuit configured to be selectively connected to the transceiving device; and a wireless power input detector configured to protect the communication circuit from a wireless power signal by detecting whether the signal is the wireless power signal which is input for charging and generating a control signal for selectively disconnecting the communication circuit from the transceiving device.

The transceiving device may be an antenna or an inductive device configured to transmit or receive the signal by generating a field or in response to a field. The communication circuit may include a near-field communication circuit or a magnetic secure transmission circuit.

The communication device may further include a protective circuit configured to selectively connect the communication circuit to the transceiving device or selectively disconnect the communication circuit from the transceiving device. When the control signal is input to the protective circuit from the wireless power input detector, the protective circuit may selectively disconnect the communication circuit from the transceiving device and selectively connect the transceiving device to the protective circuit, and thereby current may be transmitted to the protective circuit other than the communication circuit so as to protect the communication circuit from the wireless power signal. The protective circuit may include a switching device configured to be turned on by the control signal when the control signal is input thereto from the wireless power input detector.

The communication device may further include a frequency sensor configured to sense a frequency of a signal input to the communication circuit and generate a control signal for selectively disconnecting the communication circuit from the transceiving device when the sensed frequency is a frequency for wireless charging. The communication device may further include a logic circuit configured to generate a control signal by receiving the control signal from the wireless power input detector and the control signal from the frequency sensor and performing a logic operation on the received control signals.

The communication device may further include impedance devices connected between the transceiving device and the communication circuit and configured to change a resonance frequency of the communication circuit. Each of the impedance devices may include a resistor, an inductor, a capacitor, or a combination thereof.

The communication circuit may include a rectifier, and the wireless power input detector may be connected to an input of the rectifier. The communication device may further include a wireless power receiver configured to receive the wireless power signal from among signals received from the transceiving device, the wireless power receiver including the wireless power input detector.

A communication device according to another embodiment includes a communication circuit, at least one wireless power receiver, at least one wired power receiver, a power selector connected to the wireless and wired power receivers and configured to select a power input, and a wireless power input detector configured to detect a wireless power signal which is input through the selection of the power input by the power selector and configured to generate a control signal for blocking the wireless power signal from being transmitted to the communication circuit when the wireless power signal is detected.

The communication device may further include a protective circuit configured to receive the control signal from the wireless power input detector and selectively disconnect the communication circuit from the transceiving device.

A communication device according to another embodiment includes a communication circuit, at least one wireless power receiver, at least one wired power receiver, a charging circuit connected to the wireless and wired power receivers and configured to select a power input and charge a load with input power, and a wireless power input detector configured to detect a wireless power signal which is input through the selection of the power input by the charging circuit and configured to generate a control signal for blocking the wireless power signal from being transmitted to the communication circuit.

The communication device may further include a protective circuit configured to receive the control signal from the wireless power input detector and selectively disconnect the communication circuit from a transceiving device.

An electronic device according to an embodiment includes a communication circuit, a charging and communication terminal configured to be connected to a dongle device, and a processor including a wireless power input detector configured to detect an input wireless power signal through connection between the charging and communication terminal and the dongle device and configured to generate a control signal for blocking the wireless power signal from being transmitted to the communication circuit when the wireless power signal is detected. The electronic device may further include a protective circuit configured to receive the control signal from the wireless power input detector and selectively disconnect the communication circuit from a transceiving device.

The processor may generate a wireless power input detection signal by receiving a configuration for operating the electronic device, including wireless charging and communication circuit protection, from an application and provide the application with operating state information for monitoring or an execution result.

### Advantageous Effects

In one embodiment, a communication device can be protected when wireless charging is performed. In particular, a communication circuit of a communication device using an antenna or an inductive device, such as a near-field communication (NFC) device or a magnetic secure transmission (MST) device, can be protected so as to not supply excessive energy thereto due to a field applied from the outside. The communication device is protected by blocking the supply of a power signal thereto during the wireless charging. Accordingly, it is possible to prevent an inductive type communication device from being damaged due to the supply of excessive power thereto when the power signal is supplied from a power transmitting unit.

The present invention is applicable to protecting the communication device from a wireless charging system when frequency bands of the wireless charging system which transmits or receives a wireless power signal and the communication device are relatively close to each other or when the communication device is exposed to an excessive magnetic field occurring due to an increase in the amount of power to be transmitted for wireless charging although the frequency bands are significantly different.

Furthermore, the communication circuit can be protected using a selection function of a power selector or an input selection function of a charging circuit. In addition, when a dongle device is connected to a charging and communication terminal of an electronic device, the communication circuit can be protected by identifying an input of a wireless power signal through communication between the electronic device and the dongle device

### DESCRIPTION OF DRAWINGS

FIG. 1 is a block diagram illustrating a relation among a power transmitting unit (PTU), a power receiving unit (PRU), and a communication device according to an embodiment of the present invention,

FIG. 2 is a circuit diagram illustrating a state in which a near-field communication (NFC) device is placed on an Alliance for Wireless Power (A4WP) PTU which supplies power at a frequency of 6.78 MHz,

FIG. 3 is a circuit diagram illustrating measurement of power received via an NFC antenna,

FIG. 4 is a waveform diagram showing a result of measuring voltage and current of the NFC antenna in a state of the measurement of power illustrated in FIG. 3,

FIG. 5 is a reference diagram illustrating an image captured by a thermal imaging camera when a credit card equipped with an NFC chip and a cellular phone equipped with an A4WP PRU were placed on an A4WP PTU,

FIG. 6 is a circuit diagram of a communication device which protects a communication circuit according to a first embodiment of the present invention,

FIG. 7 is a circuit diagram of a communication device which protects a communication circuit according to a second embodiment of the present invention,

FIG. 8 is a circuit diagram of a communication device which protects a communication circuit according to a third embodiment of the present invention,

FIG. 9 is a block diagram of the communication device which protects a communication circuit according to the first embodiment of the present invention,

FIG. 10 is a block diagram of the communication device which protects a communication circuit according to the second embodiment of the present invention,

FIG. 11 is a block diagram of the communication device which protects a communication circuit according to the third embodiment of the present invention,

FIG. 12 is a block diagram of an electronic device which protects a communication circuit according to a first embodiment of the present invention, and

FIG. 13 is a block diagram of an electronic device which protects a communication circuit according to a second embodiment of the present invention.

### MODES OF THE INVENTION

Advantages and features of the present invention and methods of achieving them will be apparent from embodiments which will be described in detail in conjunction with the accompanying drawings. However, the present invention is not limited thereto and may be embodied in many different forms. These embodiments are merely provided so that this disclosure will be thorough and complete and will fully convey the concept of the invention to those of ordinary skill in the art. The present invention should be defined by the claims only. In the drawings, the same reference numerals represent the same elements throughout the drawings.

When embodiments of the present invention are described, well-known functions or constructions are not described in detail if it is determined that they would obscure the invention due to unnecessary detail. Terms which will be described below are defined in consideration of functions in embodiments of the present invention and thus may be defined differently according to a user or operator's intention, precedents, or the like. Accordingly, the terms used herein should be defined on the basis of the whole context of the present invention.

Each of blocks of block diagrams and combinations of operations of a flowchart in the accompanying drawings may be performed by computer program instructions (an execution engine), and the computer program instructions may be stored in a processor of a general-purpose computer, a special-purpose computer, or another kind of programmable data processing equipment. Thus, means for performing functions described with respect to the blocks of the block diagrams or the operations of the flowchart are produced from the computer program instructions that are executed through the processor of a computer or another kind of programmable data processing equipment.

The computer program instructions may be stored in a computer usable or readable memory available in a computer or another type of programmable data processing equipment to implement functions in a specific mariner. Thus, products including instruction means for performing the functions described with respect to the blocks of the block diagrams or the operations of the flowchart may be produced through the computer program instructions stored in the computer usable or readable memory.

Furthermore, the computer program instructions may be loaded to a computer or another type of programmable data processing equipment so that a series of operations nay be performed in the computer or the other type of programmable data processing equipment to create a computer executable process. Thus, the instructions for executing the computer or the other type of programmable data processing equipment may provide operations for performing the functions described with respect to the blocks of the block diagrams and the operations of the flowchart.

In addition, each of the blocks or each of the operations may represent a module, a segment, or part of code that includes one or more executable instructions for executing specified logical functions. In some alternative embodiments, the functions specified with respect to the blocks or the operations may be performed in a different order. For example, two successive blocks or operations may actually be performed substantially concurrently or may be performed in reverse order if necessary.

Hereinafter, embodiments of the present invention will be described in detail with reference to the accompanying drawings. However, various changes may be made in the following embodiments of the present invention, and the scope of the present invention is not limited by the following embodiments. These embodiments of the present invention are provided to help understanding of the present invention by those of ordinary skill in the art.

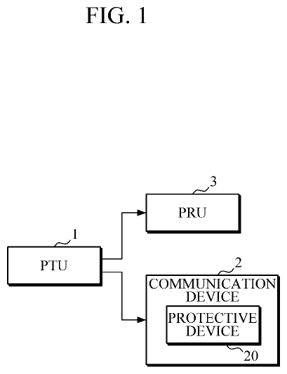

FIG. 1 is a block diagram illustrating a relation among a power transmitting unit (PTU), a power receiving unit (PRU), and a communication device according to an embodiment of the present invention.

Referring to FIG. 1, a PTU 1 performs wireless charging by wirelessly supplying a power signal to a PRU 3. A communication device 2 is a device which transmits a communication signal to or receives a communication signal from an external device and may be a wireless communication device. For example, the communication device 2 may be a near-field communication (hereinafter referred to as ‘NFC’) device or a radio-frequency identification (hereinafter referred to as ‘RFID’) device. The communication device 2 may be a magnetic secure transmission (hereinafter referred to as ‘MST’) device.

The NFC device performs short-range wireless communication in a frequency band of several to several tens of MHz. For example, the NFC device transmits or receives a radio signal in a frequency band of 13.56 MHz. When an MST device is used, e.g.., when a smartphone inserted into a device containing credit card information is touched to a credit card payment terminal, this terminal automatically reads the credit card information to automatically make a payment. An NFC method need not be used, since the payment is made by wirelessly transmitting information of a magnetic credit card.

The communication device 2 transmits or receives a signal through one or at least two among a magnetic field, an electric field, and an electromagnetic field. For convenience of explanation, a case in which the communication device 2 transmits or receives a signal through the magnetic field will be described below but the type of a field available in this case is not limited to the magnetic field. The communication device 2 may transmit or receive a signal by generating the magnetic field or through a transceiving device in response to the magnetic field. An example of the transceiving device includes an antenna or an inductive device.

A protective device 20 of the communication device 2 protects the communication device 2 from a power signal for wireless charging. The PTU 1 and the PRU 3 may transmit or receive power through magnetic resonance or an inductive method. When the PTU 1 supplies power for wireless charging, excessive power may be unintentionally supplied to the communication device 2 configured to transmit or receive low power and thus the communication device 2 may be damaged. The protective device 20 protects the communication device 2 from the power signal when wireless charging is performed. In particular, the protective device 20 prevents the communication device 2 from being broken due to the supply of excessive power thereto from the outside.

The PRU 3 and the communication device 2 may be separated from each other or may be included in one electronic device. An example in which the PRU 3 and the communication device 2 are separated from each other includes a case in which the PRU 3 is located in a portable terminal and the communication device 2 is located in a credit card. An example in which the PRU 3 and the communication device 2 are included in one electronic device includes a case in which the PRU 3 and the communication device 2 are located in a portable terminal. In any case, the communication device 2 is influenced by a power signal transmitted from the PTU 1. The present invention is directed to a technique for protecting the communication device 2 from the influence of such a power signal.

In one embodiment, the PTU 1 and the PRU 3 employ a magnetic resonance method. For example, the PTU 1 and the PRU 3 transmit or receive power by an Alliance for Wireless Power (A4WP) method. In the A4WP method, an A4WP PTU supplies a power signal to an A4WP PRU in a frequency band of 6.78 MHz through magnetic resonance. For convenience of explanation, the A4WP method will be described below, but a wireless charging method of the present invention is not limited to the A4WP method. For example, when the A4WP method is not employed but wireless charging is performed using a frequency band different from that of the communication device 2, e.g., when wireless charging is performed at 4 MHz, the protective device 20 may protect the communication device 2 using a frequency band of 13.56 MHz or a frequency band close thereto.

The present invention is applicable to protecting a communication device from a wireless charging system when frequency bands of the wireless charging system transmitting or receiving a wireless power signal and the communication device 2 are relatively close to each other or when the frequency bands are significantly different but the communication device is exposed to an excessive magnetic field occurring due to an increase in the amount of power to be transmitted for wireless charging. For example, the present invention is applicable to protecting a communication device, e.g., an NFC device, using a frequency band of 13.56 MHz from an A4WP wireless charging system using a frequency band of 6.78 MHz.

Hereinafter, to aid in understanding of the present invention, embodiments in which the communication device 2 is an NFC device, the PTU 1 is an A4WP power transmitting unit, and the PRU 3 is an A4WP PRU, and the NFC device is protected from the A4WP PTU will be described with reference to the drawings which will be described below, but the present invention is not limited thereto.

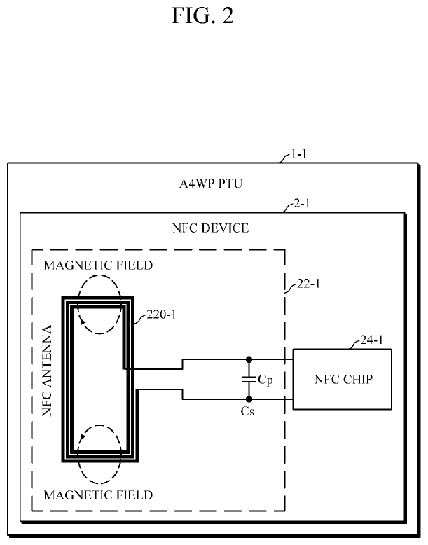

FIG. 2 is a circuit diagram illustrating a case in which an NFC device is placed on an A4WP PTU supplying power at a frequency of 6.78 MHz.

Referring to FIG. 2, an NFC device 2-1 includes a resonator 22-1 having an NFC antenna 220-1 and capacitors Cs and Cp, and an NFC chip 24-1. Although NFC is not used, when the NFC device 2-1 is located on an A4WP PTU 1-1, the NFC antenna 220-1 of the NFC device 2-1 is exposed to a magnetic field supplied from the A4WP PTU 1-1. When operating frequencies used in NFC and A4WP are compared, the operating frequency used in NFC is two times higher than that used in the A4WP, i.e., different frequency bands are used, but a substantially large amount of power may be received by the NFC antenna 220-1.

When the A4WP PTU 1-1 is installed in a portable terminal such as a cellular phone, a display is mounted on a front surface of the portable terminal and an A4WP antenna and the NFC antenna 220-1 are generally located on a rear surface thereof. Thus, even when NFC using the NFC antenna 220-1 is not conducted, the NFC antenna 220-1 is exposed to a magnetic field supplied from the A4WP PTU 1-1 and a magnetic field is generated during wireless charging. Accordingly, a considerably high power signal may also be received by the NFC antenna 220-1.

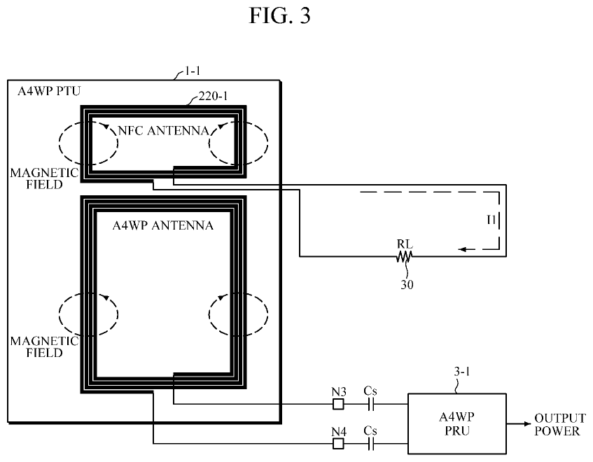

FIG. 3 is a circuit diagram illustrating measurement of power received via an NFC antenna.

Referring to FIG. 3, it is assumed that, when power is transmitted or received between an A4WP PTU 1-1 and an A4WP PRU 3-1, a resistor RL 30 of 10 ohms (Ω) is attached to an NFC antenna 220-1 and the NFC antenna 220-1 is placed on the A4WP PTU 1-1 to measure the amount of power received via the NFC antenna 220-1. In this case, the A4WP PRU 3-1 receives power of about 5 W from the A4WP PTU 1-1.

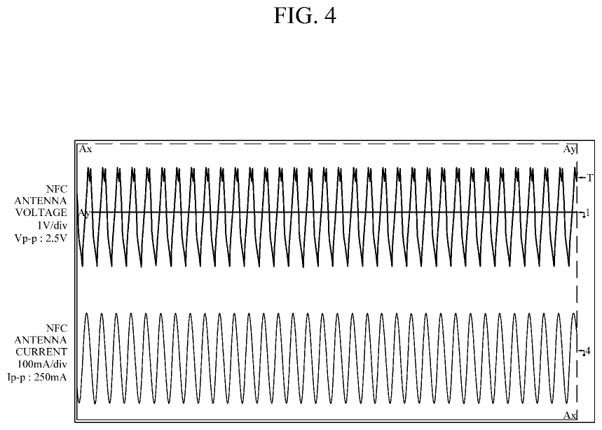

FIG. 4 is a waveform diagram showing a result of measuring voltage and current of an NFC antenna when power was measured as illustrated in FIG. 3.

Referring to FIGS. 3 and 4, the NFC antenna 220-1 received about peak 2.5 V and a current flowing thereto was peak 250 mA. Although the voltage and current of the NFC antenna 220-1 are determined by functions influenced by the distance between the NFC antenna 220-1 and the A4WP PTU 1-1 and a location of the NFC antenna 220-1, a result of measuring the voltage and current of the NFC antenna 220-1 by placing the NFC antenna 220-1 at a midpoint on the A4WP PTU 1-1 and setting a height of the NFC antenna 220-1 from the A4WP PTU 1-1 to zero is as shown in FIG. 4. A maximum value of power output from the A4WP PTU 1-1 was about 15 W but a level of power to be transmitted from the A4WP PTU 1-1 as an experimental condition was about 10 W.

An experimental result revealed that about 0.3 W of power was received by the NFC antenna 220-1. Although the about 0.3 W of power is not high in terms of the A4WP PRU 3-1, the about 0.3 W of power may cause a big problem to occur in an NFC device.

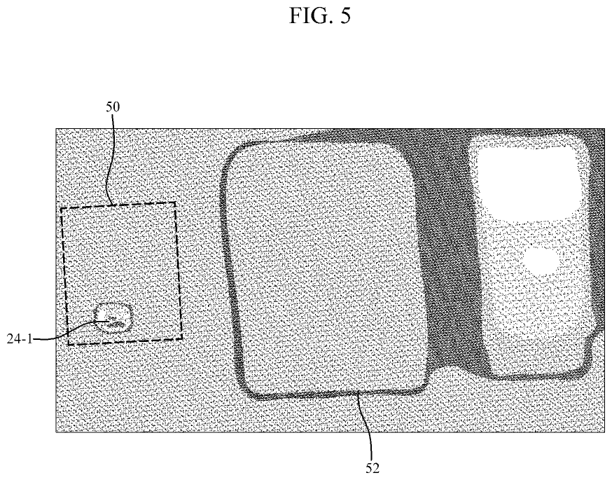

FIG. 5 is a reference diagram illustrating an image captured by a thermal imaging camera when a credit card equipped with NFC chip and a cellular phone equipped with an A4WP PRU were placed on an A4WP PTU.

Referring to FIG. 5, when a credit card 50 equipped with an NFC chip 24-1 and a cellular phone 52 equipped with an A4WP PRU were placed on an A4WP PTU, the NFC chip 24-1 of the credit card 50 received power and thus was overheated. When this state was maintained for a certain time period, e.g., ten minutes, the NFC chip 24-1 having an NFC function was damaged.

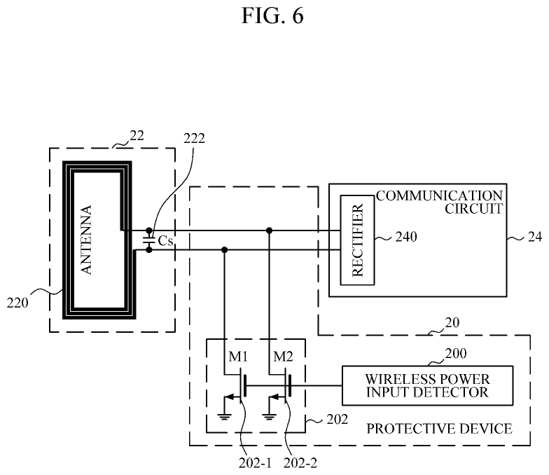

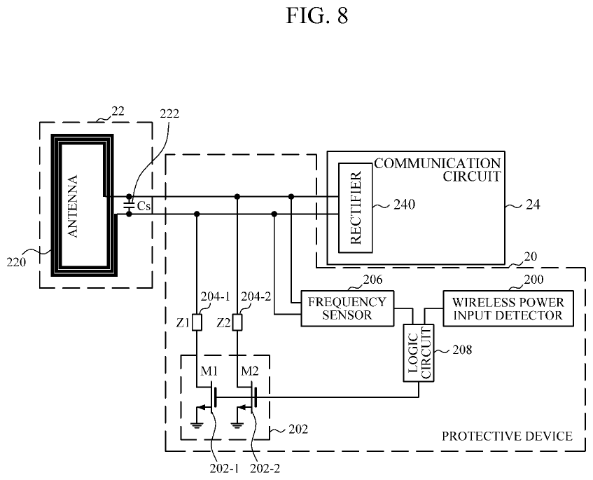

Examples of a circuit structure of a communication device protecting a communication circuit according to various embodiments of the present invention will be described with reference to FIGS. 6 and 8 below.

FIG. 6 is a circuit diagram of a communication device which protects a communication circuit according to a first embodiment of the present invention.

Referring to FIG. 6, a communication device 2 includes a resonator 22, a communication circuit 24, and a protective device 20. The protective device 20 may include a wireless power input detector 200 and may further include a protective circuit 202.

The resonator 22 includes an antenna 220 and a capacitor Cs 222. The antenna 220 includes an inductance component. An inductive device may be provided instead of the antenna 220. A transceiving device such as the antenna 220 or the inductive device generates a magnetic field or transmits or receives a signal in response to a magnetic field. When the communication device 2 is an NFC device, the antenna 220 may be an NFC antenna.

The communication circuit 24 is selectively connected to the antenna 220. If the communication circuit 24 and the antenna 220 are connected to each other, the communication circuit 24 receives input data from the antenna 220 when the antenna 220 receives the input data from an external device through a magnetic field during a receiving operation. During a transmission operation, the communication circuit 24 provides output data to the antenna 220, and the antenna 220 transmits the output data to an external device through a magnetic field. In contrast, the antenna 220 and the communication circuit 24 may be disconnected from each other when the antenna 220 receives a wireless power signal according to a control signal from the protective device 20.

When the communication device 2 is an NFC device, the communication circuit 24 may be an NFC chip. When the communication device 2 is an MST device, the communication circuit 24 may be an MST circuit. The communication circuit 24 may include a rectifier 240. The rectifier 240 rectifies an alternating-current (AC) signal received from the resonator 22 into a direct-current (DC) signal.

The wireless power input detector 200 of the protective device 20 detects whether a signal received via the antenna 220 is a wireless power signal for charging. In this case, when the wireless power signal is detected, the wireless power input detector 200 generates a control signal for selectively disconnecting the communication circuit 24 from the antenna 220. The communication circuit 24 may be protected from the wireless power signal due to the control signal. The signal received via the antenna 220 may be a wireless power signal received from a PTU or a communication signal transmitted from an external device for data communication. In this case, the wireless power input detector 200 detects a wireless power signal from among signals received via the antenna 220 and blocks the wireless power signal from being transmitted to the communication circuit 24 when the wireless power signal is detected, thereby protecting the communication circuit 24 from the wireless power signal. As illustrated in FIG. 6, the control signal is generated by the wireless power input detector 200 but may be generated by a controller such as a micro-controller unit (MCU), a buffer, or the like.

The protective circuit 202 selectively connects the communication circuit 24 to the antenna 220 or selectively disconnects the communication circuit 24 from the antenna 220. In this case, when the control signal is input to the protective circuit 202 from the wireless power input detector 200, the protective circuit 202 selectively disconnects the communication circuit 24 from the antenna 220.

In one embodiment, the protective circuit 202 includes a switching device configured to be turned on by the control signal when the control signal is input thereto from the wireless power input detector 200. For example, the protective circuit 202 includes switching devices M1 202-1 and M2 202-2. Outputs of the first switching device M1 202-1 and the second switching device M2 202-2 are connected to a ground voltage source and the antenna 220, and inputs thereof are connected to the control signal output from the wireless power input detector 200 and thus are turned on by the control signal.

A PTU and a PRU transmit or receive a wireless power signal through magnetic resonance, and the communication device 2 conducts wireless communication using a magnetic field at an operating frequency. In this case, when frequency bands of the PTU and the PRU are close to each other, the antenna 220 is influenced by a magnetic field generated by the PTU and thus a magnetic field is generated therein during the supply of the wireless power signal from the PTU. The wireless power input detector 200 protects the communication circuit 24 by blocking the supply of the wireless power signal to the communication circuit 24 due to the magnetic field generated by the antenna 220.

In detail, the wireless power input detector 200 detects a wireless power signal from among signals input via the antenna 220 or the PRU. The wireless power signal is differentiated from a signal for data communication. When the wireless power signal is detected, the wireless power input detector 200 determines that wireless charging is being conducted through transmission of the wireless power signal from the PTU to the PRU. In this case, the wireless power input detector 200 supplies a control signal for protecting the communication circuit 24 to the protective circuit 202 so as to block the transmission of the wireless power signal to the communication circuit 24 via the antenna 220. Accordingly, the communication circuit 24 may be protected during the wireless charging. In contrast, when no wireless power signal is detected by the wireless power input detector 200, e.g., when a data communication signal is received from an external device via the antenna 220, the control signal causing the protective circuit 202 to be turned on is not supplied to the protective circuit 202 and thus the protective circuit 202 is turned off, thereby transmitting the data communication signal received via the antenna 220 to the communication circuit 24.

A process of protecting the communication circuit 24 will be described with reference to the circuit of FIG. 6 below.

When the PTU supplies a power signal, the wireless power input detector 200 detects the power signal and generates a control signal, and the switching devices M1 202-1 and M2 202-2 are turned on according to the control signal. When the switching devices M1 202-1 and M2 202-2 are turned on, a maximum amount of antenna current flows through the switching devices M1 202-1 and M2 202-2 and thus the antenna current is blocked from flowing to the communication circuit 24 including the rectifier 240, thereby protecting the communication circuit 24 from a wireless power signal. When no wireless power signal is detected by the wireless power input detector 200, the switching devices M1 202-1 and M2 202-2 are turned off and thus the antenna current is supplied to the communication circuit 24. A case in which no wireless power signal is detected by the wireless power input detector 200 includes a case in which a data communication signal is transmitted via the antenna 220.

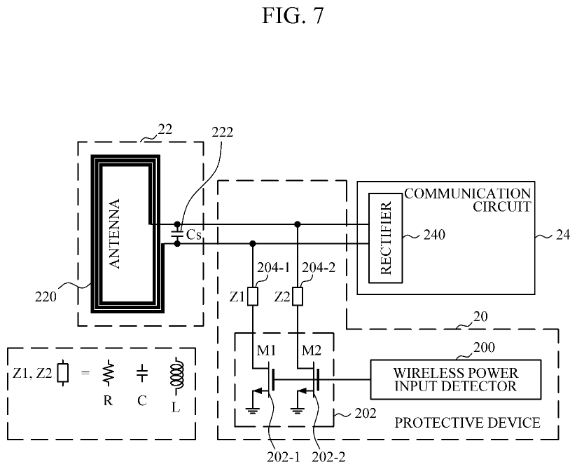

FIG. 7 is a circuit diagram of a communication device which protects a communication circuit according to a second embodiment of the present invention.

The communication device of FIG. 7 further includes impedance devices Z1 204-1 and Z2 204-2, as compared to the communication device 2 of FIG. 6. If a communication circuit 24 is protected using switching devices M1 202-1 and M2 202-2, excessive current may be supplied to the switching devices M1 202-1 and M2 202-2 via an antenna 220 when turn-on resistances of the switching devices M1 202-1 and M2 202-2 are low. Thus, as illustrated in FIG. 7, the impedance devices Z1 204-1 and Z2 204-2 are provided between the antenna 220 and the communication circuit 24 to change a resonance frequency of a resonator 22 and prevent excessive current from flowing to the switching devices MI 202-1 and M2 202-2. In this case, the amount of received current may be reduced by reducing the resonance frequency of the resonator 22 to be lower than a frequency input to the antenna 220.

A structure of a protective device 20 will be described with reference to FIG. 7 below. The protective device 20 includes a wireless power input detector 200, the switching devices M1 202-1 and M2 202-2, and the impedance devices Z1 204-1 and Z2 204-2. An output of the first switching device M1 202-1 is connected to a ground voltage source and the impedance device Z1 204-1, and an input thereof is connected to a control signal generated by the wireless power input detector 200 and thus is turned on by the control signal. An output of the second switching device M2 202-2 is connected to the ground voltage source and the impedance device Z2 204-2, and an input thereof is connected to the control signal generated by the wireless power input detector 200 and thus is turned on by the control signal.

Each of the impedance devices Z1 5424-1 and Z2 5424-2 limiting current may be, for example, a resistor R, an inductor L or a capacitor C. Alternatively, each of the impedance devices Z1 5424-1 and Z2 5424-2 may be a combination of at least two among the resistor R, the inductor L, and the capacitor C. When the resistor R is connected to the switching devices M1 202-1 and M2 202-2, the amount of current flowing through the switching devices M1 202-1 and M2 202-2 may be reduced but the communication circuit 24 may be difficult to protect when the amount of current received by the antenna 220 is large. Thus, the resistor R should be appropriately controlled. When the inductor L is connected to the switching devices M1 202-1 and M2 202-2, a resonance frequency of the resonator 22 may be changed to reduce a level of energy to be received. When the capacitor C is connected to the switching devices M1 202-1 and M2 202-2, the capacitor C is provided between the antenna 220 and the communication circuit 24 to shift the resonance frequency of the resonator 22.

FIG. 8 is a circuit diagram of a communication device which protects a communication circuit according to a third embodiment of the present invention.

The communication device of FIG. 8 further includes a frequency sensor 206, as compared to the communication device of FIG. 7. In some cases, a communication circuit 24 may be protected by determining whether a specific frequency is input by using the frequency sensor 206 which senses a frequency from an input signal of a rectifier 240 of the communication circuit 24.

In detail, the protective device 20 includes a wireless power input detector 200, a protective circuit 202, impedance devices 204-1 and 204-2, the frequency sensor 206, and a logic circuit 208. The wireless power input detector 200 detects a wireless power signal and generates a control signal for protecting the communication circuit 24. The frequency sensor 206 senses a frequency of a rectifier input signal input to the rectifier 240 of the communication circuit 24 and determines that wireless charging is being conducted and generates a control signal for protecting the communication circuit 24 when the sensed frequency is a frequency for wireless charging. The logic circuit 208 receives the control signal from the wireless power input detector 200 and the control signal from the frequency sensor 206, performs an AND operation or an OR operation thereon, and outputs a control signal for protecting the communication circuit 24. The control signal is transmitted to the protective circuit 202 and thus the protective circuit 202 is turned on. Accordingly, antenna current is transmitted to the protective circuit 202 from the antenna 220 and the communication circuit 24 may be protected thereby from the wireless power signal.

The circuit of FIG. 8 may be embodied in various ways. The circuit of FIG. 8 may be fabricated by integrating the wireless power input detector 200, the protective circuit 202, the frequency sensor 206, etc. onto the communication circuit 24, and may be embodied as an external circuit of the communication circuit 24 as illustrated in FIG. 8.

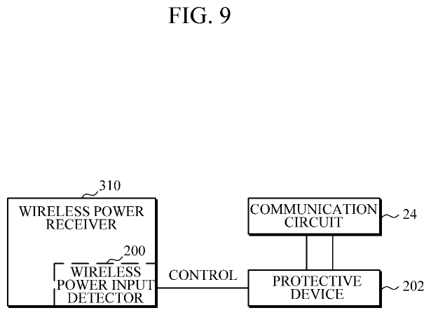

Structures of communication devices and electronic devices which protect a communication circuit according to various embodiments of the present invention will be described with reference to FIGS. 9 to 13 below.

FIG. 9 is a block diagram of a communication device which protects a communication circuit according to the first embodiment of the present invention.

Referring to FIG. 9, the communication device includes a communication circuit 24, a wireless power receiver 310, and a protective circuit 202. The wireless power receiver 310 includes a wireless power input detector 200.

A transceiving device such as an antenna or an inductance device is connected to the communication circuit 24. The transceiving device receives a signal, and the received signal may be a data communication signal or a wireless power signal. In order to transmit or receive the data communication signal, the transceiving device is connected to the communication circuit 24. When the wireless power signal for charging is received by the transceiving device, the wireless power receiver 310 receives the wireless power signal from the transceiving device, and the wireless power input detector 200 of the wireless power receiver 310 detects the wireless power signal. When the wireless power signal is detected, the wireless power input detector 200 generates a control signal for protecting the communication circuit 24. The wireless power input detector 200 selectively connects the communication circuit 24 to the transceiving device or selectively disconnects the communication circuit 24 from the transceiving device according to the control signal.

In one embodiment, the wireless power receiver 310 is operated by sensing a wireless power signal input from the outside through the wireless power input detector 200, and at the same time generates a control signal for protecting the communication circuit 24 and transmits the control signal to the protective circuit 202. To this end, the wireless power receiver 310 is connected to the protective circuit 202 and an output of the protective circuit 202 is connected to the transceiving device. When the transceiving device receives communication data, the transceiving device is connected to the communication circuit 24 and transmits the communication data to the communication circuit 24. In contrast, when the protective circuit 202 receives a control signal, the protective circuit 202 is activated and thus is connected to the transceiving device and disconnected from the communication circuit 24. Accordingly, a maximum amount of current is suppressed from flowing to the communication circuit 24 due to the control signal and flows to the protective circuit 202, thereby protecting the communication circuit 24, including a rectifier (not shown), from wireless power.

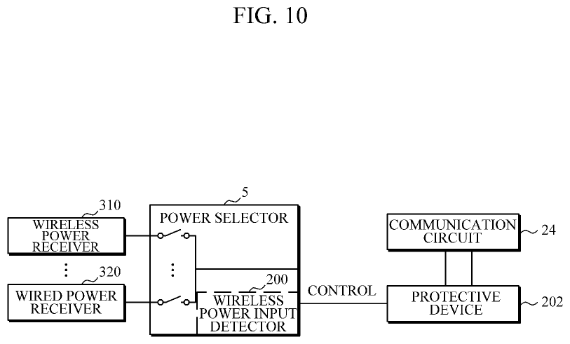

FIG. 10 is a block diagram of the communication device which protects a communication circuit according to the second embodiment of the present invention.

Referring to FIG. 10, the communication device may include at least one wireless power receiver 310, at least one wired power receiver 320, a power selector 5, and a communication circuit 24, and may further include a protective circuit 202. The power selector 5 may include a wireless power input detector 200.

The wireless power receiver 310 wirelessly receives power and supplies the power to each module, and the wired power receiver 320 receives power and supplies the power to each module via wire. The power selector 5 is connected to power receiving circuits 200, . . . , 300 and selects a power source from among various types of input power sources. In this case, one or more power sources may be selected from among the input various types of power sources. The wireless power input detector 200 detects a wireless power signal from among signals selected and input through the power selector 5 and generates a control signal for protecting the communication circuit 24 when the wireless power signal is detected. The protective circuit 202 receives the control signal from the wireless power input detector 200 and blocks the wireless power signal from being transmitted to the communication circuit 24. For example, the protective circuit 202 selectively disconnects the communication circuit 24 from a transceiving device and connects the transceiving device and the protective circuit 202. The transceiving device includes an antenna or an inductive device which generates a magnetic field or transmits or receives a signal in response to a magnetic field.

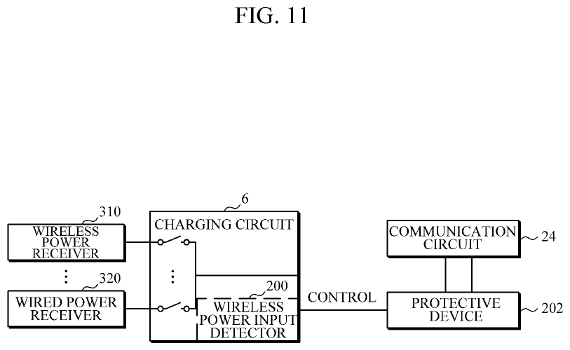

FIG. 11 is a block diagram of the communication device which protects a communication circuit according to the third embodiment of the present invention.

Referring to FIG. 11, the communication device may include at least one wireless power receiver 310, at least one wired power receiver 320, a charging circuit 6, and a communication circuit 24 and may further include a protective circuit 202. The charging circuit 6 may include a wireless power input detector 200.

When either a plurality of charging devices or the charging circuit 6 capable of accommodating a plurality of power inputs is included in the communication device, the charging circuit 6 detects whether wireless power is input or not through a selection or identification function thereof according to each input power source and generates a control signal for protecting the communication circuit 24. The charging circuit 6 is connected to power receiving circuits 200, ..., 300 and charges a load by selecting a power input. In this case, the wireless power input detector 200 of the charging circuit 6 detects an input of a wireless power signal through selection of a power source by the charging circuit 6 and generates a control signal for blocking the wireless power signal from being transmitted to the communication circuit 24. The protective circuit 202 receives the control signal from the wireless power input detector 200 and blocks the wireless power signal from being transmitted to the communication circuit 24. For example, the protective circuit 202 selectively disconnects the communication circuit 24 from a transceiving device and connects the transceiving device and the protective circuit 202. The transceiving device includes an antenna or an inductive device which generates a magnetic field or transmits or receives a signal in response to a magnetic field.

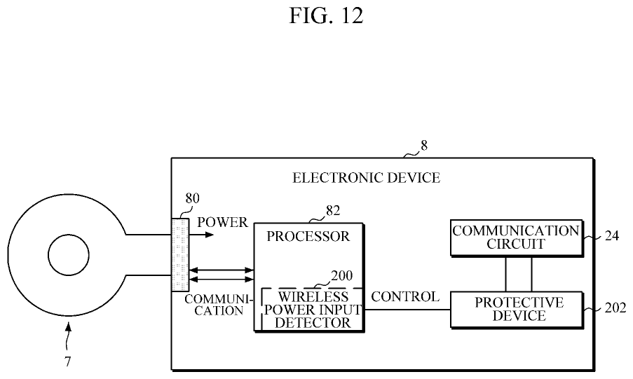

FIG. 12 is a block diagram of an electronic device which protects a communication circuit according to a first embodiment of the present invention.

Referring to FIG. 12, an electronic device 8 may include a charging and communication terminal 80, a processor 82, and a communication circuit 24 and may further include a protective circuit 202. The processor 82 may include a wireless power input detector 200. The electronic device may be, for example, a smart device.

The charging and communication terminal 80 receives a wireless power signal for charging, or transmits or receives a signal for data communication. The charging and communication terminal 80 may be a Universal Serial Bus (USB) type or a lightning type. The electronic device 8 may conduct charging or data communication by connecting a dongle device 7 to the charging and communication terminal 80.

In this case, the processor 82 may include the wireless power input detector 200 and may be an MCU or an application processor. When the dongle device 7 is connected to the charging and communication terminal 80 of the electronic device 8, the wireless power input detector 200 may protect the communication circuit 24 by detecting a wireless power signal through communication between the electronic device 8 and the dongle device 7.

When the dongle device 7 is connected to the charging and communication terminal 80, signals are input via the charging and communication terminal 80 and then the wireless power input detector 200 of the processor 82 detects a wireless power signal from among the input signals and generates a control signal for protecting the communication circuit 24 when the wireless power signal is detected. The control signal may be supplied to the protective circuit 202 so that the protective circuit 202 may block the wireless power signal from being transmitted to the communication circuit 24. For example, the protective circuit 202 may selectively disconnect the communication circuit 24 from a transceiving device and connect the transceiving device and the protective circuit 202. Accordingly, a maximum amount of current does not flow through the communication circuit 24 and flows to the protective circuit 202, thereby protecting the communication circuit 24, including a rectifier (not shown), from wireless power.

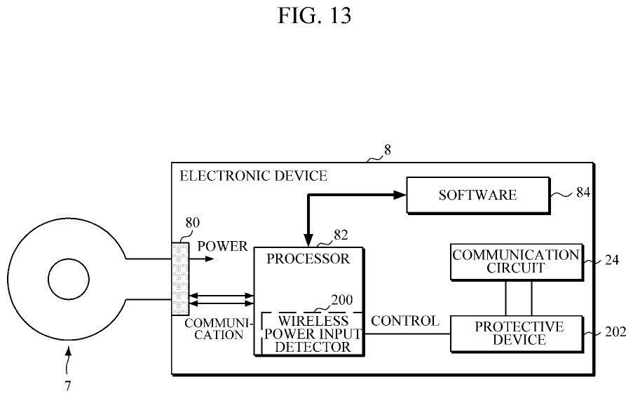

FIG. 13 is a block diagram of an electronic device which protects a communication circuit according to a second embodiment of the present invention.

An electronic device 8 of FIG. 13 further includes software 84, as compared to the electronic device of FIG. 12. Operations of the electronic device 8, including wireless charging and communication circuit protection, may be set according to an instruction to configure the software 84 as an application. In this case, a control signal for protecting a communication circuit 24 may be generated on the basis of the configuration of the software 84. At this time, the processor 82 may generate a wireless power input detection signal by receiving a configuration for wireless charging and communication circuit protection from the software 84 arid provides the software 84 with information regarding an operating state for monitoring or an execution result. The software 84 may be installed into or downloaded to the electronic device 8 as illustrated in Fla 13 or may be located on the outside and thus the electronic device 8 may access the software 84 on the web via the Internet.

As described above with reference to the appended drawings, a communication circuit included in either a communication device or an electronic device, which transmits a signal via an antenna or an inductive device, such as an NFC device or an MST device, may be prevented from being damaged due to an excessive supply of energy thereto from a field supplied from the outside.

The present invention has been described above with respect to embodiments thereof. It will be apparent to those of ordinary skill in the technical field to which the present invention pertains that the present invention may be embodied in different forms without departing from essential features thereof. Accordingly, the embodiments set forth herein should be considered in a descriptive sense only and not for purposes of limitation. The scope of the present invention is defined in the appended claims other than the above description, and all differences falling within the same range as the scope of the present invention should be understood as being included in the present invention.

1. A communication device comprising:
a transceiving device configured to transmit or receive a signal;
a communication circuit configured to be selectively connected to the transceiving device; and
a wireless power input detector configured to protect the communication circuit from a wireless power signal by detecting whether the signal is the wireless power signal which is input for charging and generating a control signal for selectively disconnecting the communication circuit from the transceiving device.

2. The communication device of claim 1, wherein the transceiving device comprises an antenna or an inductive device configured to generate a field or transmit or receive the signal in response to a field.

3. The communication device of claim 1, wherein the communication circuit comprises a near-field communication circuit or a magnetic secure transmission circuit.

4. The communication device of claim 1, further comprising a protective circuit configured to selectively connect the communication circuit to the transceiving device or selectively disconnect the communication circuit from the transceiving device.

5. The communication device of claim 4, wherein, when the control signal is input to the protective circuit from the wireless power input detector, the protective circuit selectively disconnects the communication circuit from the transceiving device and selectively connects the transceiving device to the protective circuit, and thereby current is transmitted to the protective circuit other than the communication circuit so as to protect the communication circuit from the wireless power signal.

6. The communication device of claim 4, wherein the protective circuit comprises a switching device configured to be turned on by the control signal when the control signal is input thereto from the wireless power input detector.

7. The communication device of claim 1, further comprising a frequency sensor configured to sense a frequency of a signal input to the communication circuit and generate a control signal for selectively disconnecting the communication circuit from the transceiving device when the sensed frequency is a frequency for wireless charging.

8. The communication device of claim 7, further comprising a logic circuit configured to generate a control signal by receiving the control signal from the wireless power input detector and the control signal from the frequency sensor and performing a logic operation on the received control signals.

9. The communication device of claim 1, further comprising impedance devices connected between the transceiving device and the communication circuit and configured to change a resonance frequency of the communication circuit.

10. The communication device of claim 9, wherein each of the impedance devices comprises a resistor, an inductor, a capacitor, or a combination thereof.

11. The communication device of claim 1, wherein the communication circuit comprises a rectifier,
wherein the wireless power input detector is connected to an input of the rectifier.

12. The communication device of claim 1, further comprising a wireless power receiver configured to receive the wireless power signal from among signals received from the transceiving device, the wireless power receiver including the wireless power input detector.

13. A communication device comprising:
a communication circuit;
at least one wireless power receiver;
at least one wired power receiver;
a power selector connected to the wireless and wired power receivers and configured to select a power input; and
a wireless power input detector configured to detect a wireless power signal which is input through the selection of the power input by the power selector and configured to generate a control signal for blocking the wireless power signal from being transmitted to the communication circuit when the wireless power signal is detected.

14. The communication device of claim 13, further comprising a protective circuit configured to receive the control signal from the wireless power input detector and selectively disconnect the communication circuit from the transceiving device.

15. A communication device comprising:
a communication circuit;
at least one wireless power receiver;
at least one wired power receiver;
a charging circuit connected to the wireless and wired power receivers and configured to select a power input and charge a load with input power; and
a wireless power input detector configured to detect a wireless power signal which is input through the selection of the power input by the charging circuit and configured to generate a control signal for blocking the wireless power signal from being transmitted to the communication circuit.

16. The communication device of claim 15, further comprising a protective circuit configured to receive the control signal from the wireless power input detector and selectively disconnect the communication circuit from a transceiving device.

17. An electronic device comprising:
a communication circuit;
a charging and communication terminal configured to be connected to a dongle device; and
a processor including a wireless power input detector configured to detect an input wireless power signal through connection between the charging and communication terminal and the dongle device and configured to generate a control signal for blocking the wireless power signal from being transmitted to the communication circuit when the wireless power signal is detected.

18. The electronic device of claim 17, further comprising a protective circuit configured to receive the control signal from the wireless power input detector and selectively disconnect the communication circuit from a transceiving device.

19. The electronic device of claim 17, wherein the processor generates a wireless power input detection signal by receiving a configuration for operating the electronic device, including wireless charging and communication circuit protection, from an application, or provides the application with operating state information for monitoring and an execution result.
